(19) United States
(12) Patent Application Publication
(10) Pub. No.: US 2022/0319016 A1
(43) Pub. Date: Oct. 6, 2022

(54) PANOPTIC SEGMENTATION FORECASTING FOR AUGMENTED REALITY

(71) Applicant: Niantic, Inc., San Francisco, CA (US)

(72) Inventors: Colin Graber, Urbana, IL (US); Grace Shin-Yee Tsai, Campbell, CA (US); Michael David Firman, London (GB); Gabriel J. Brostow, London (GB); Alexander Schwing, Champaign, IL (US)

(21) Appl. No.: 17/714,341

(22) Filed: Apr. 6, 2022

Related U.S. Application Data
(60) Provisional application No. 63/171,575, filed on Apr. 6, 2021.

(51) Int. Cl. G06T 7/215; G06T 7/194; G06T 19/00; G06V 10/28; G06V 10/70; G06T 7/55

(52) U.S. Cl. CPC G06T 7/215; G06T 7/194; G06T 19/006; G06V 10/28; G06V 10/70; G06T 7/55; G06T 2207/10016; G06T 2207/10028

(57) ABSTRACT

Panoptic segmentation forecasting predicts future positions of foreground objects and background objects separately. An egomotion model may be implemented to estimate egomotion of the camera. Pixels in frames of captured video are classified between foreground and background. The foreground pixels are grouped into foreground objects. A foreground motion model forecasts motion of the foreground objects to a future timestamp. A background motion model backprojects the background pixels into point clouds in a three-dimensional space. The background motion model predicts future positions of the point clouds based on egomotion. The background motion model may further generate novel point clouds to fill in occluded space. With the predicted future positions, the foreground objects and the background pixels are combined into a single panoptic segmentation forecast. An augmented reality mobile game may utilize the panoptic segmentation forecast to accurately portray movement of virtual elements in relation to the real-world environment.

### CROSS-REFERENCE TO RELATED APPLICATIONS

The present application claims priority to U.S. Provisional Application No. 63/171,575 filed on Apr. 6, 2021, which is incorporated by reference.

### BACKGROUND

### 1. Technical Field

The subject matter described relates generally to forecasting object positions from input image frames captured by a camera.

### 2. Problem

In augmented reality (AR) applications, a virtual environment is co-located with a real-world environment. If the pose of a camera capturing images of the real-world environment (e.g., a video feed) is accurately determined, virtual elements can be overlaid on the depiction of the real-world environment with precision. For example, a virtual hat may be placed on top of a real statue, a virtual character may be depicted partially behind a physical object, and the like.

As real-world objects move around, virtual elements may lag behind due to unknown motion of the real-world objects. This breaks the perception of augmented reality. Following the example above, a real-world person augmented with a virtual hat may be moving in the environment. Without predicting motion of the real-world person, the virtual hat would trail behind the individual as there would be a lag while attempting to update the virtual hat to a current position, though the individual may have moved by that point. This problem is only exacerbated with faster moving objects such as cars. Though object motion models exist, these models are not well-equipped to accurately and precisely forecast motion of all objects in a scene, given that various objects in a scene have unique movement while other objects in the scene are stationary.

### SUMMARY

The present disclosure describes approaches to panoptic segmentation forecasting. Panoptic segmentation forecasting forecasts future positions of foreground objects and background objects separately. Panoptic segmentation incorporates classification of pixels into foreground objects and background objects. A foreground motion model anticipates future positions of foreground objects based on their motion determined from input frames. A background motion model is applied to each frame to anticipate future positions of background objects based on an estimated depth of each pixel. Anticipated foreground positions are layered onto the anticipated background to generate a future panoptic segmentation. An egomotion model may be separately trained and implemented to predict egomotion of the camera assembly.

Applications of the panoptic segmentation forecasting may include generating virtual images in augmented reality applications based on the future panoptic segmentation. Generated virtual images may interact seamlessly with objects in the real-world provided accurate panoptic segmentation forecasting. Other applications of panoptic segmentation forecasting include autonomous navigation of an agent.

### BRIEF DESCRIPTION OF THE DRAWINGS

FIG. 1 illustrates a networked computing environment, in accordance with one or more embodiments.

FIG. 2 depicts a representation of a virtual world having a geography that parallels the real world, in accordance with one or more embodiments.

FIG. 3 depicts an exemplary game interface of a parallel reality game, in accordance with one or more embodiments.

FIG. 4 is a block diagram illustrating the architecture of the panoptic segmentation module, in accordance with one or more embodiments.

FIG. 5 is a flowchart describing a general process of panoptic segmentation forecasting, in accordance with one or more embodiments.

FIG. 6 illustrates an example computer system suitable for use in training or applying a depth estimation model, according to one or more embodiments.

The figures and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures.

### DETAILED DESCRIPTION

### Exemplary Location-Based Parallel Reality Gaming System

Various embodiments are described in the context of a parallel reality game that includes augmented reality content in a virtual world geography that parallels at least a portion of the real-world geography such that player movement and actions in the real-world affect actions in the virtual world and vice versa. Those of ordinary skill in the art, using the disclosures provided herein, will understand that the subject matter described is applicable in other situations where panoptic segmentation forecasting is desirable. In addition, the inherent flexibility of computer-based systems allows for a great variety of possible configurations, combinations, and divisions of tasks and functionality between and among the components of the system. For instance, the systems and methods according to aspects of the present disclosure can be implemented using a single computing device or across multiple computing devices (e.g., connected in a computer network).

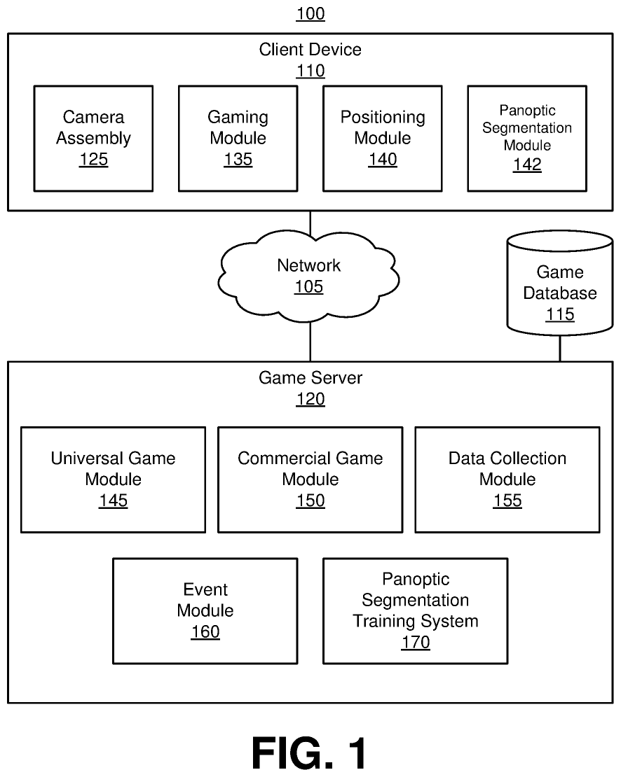

FIG. 1 illustrates a networked computing environment 100, in accordance with one or more embodiments. The networked computing environment 100 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 110 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 110.

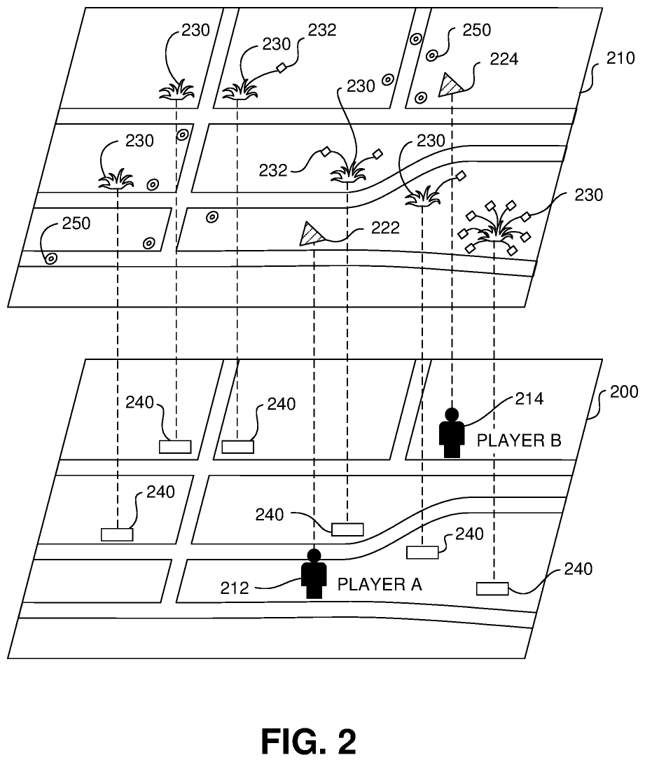

Reference is now made to FIG. 2 which depicts a conceptual diagram of a virtual world 210 that parallels the real world 200 that can act as the game board for players of a parallel reality game, according to one embodiment. As illustrated, the virtual world 210 can include a geography that parallels the geography of the real world 200. In particular, a range of coordinates defining a geographic area or space in the real world 200 is mapped to a corresponding range of coordinates defining a virtual space in the virtual world 210. The range of coordinates in the real world 200 can be associated with a town, neighborhood, city, campus, locale, a country, continent, the entire globe, or other geographic area. Each geographic coordinate in the range of geographic coordinates is mapped to a corresponding coordinate in a virtual space in the virtual world.

A player's position in the virtual world 210 corresponds to the player's position in the real world 200. For instance, the player A located at position 212 in the real world 200 has a corresponding position 222 in the virtual world 210. Similarly, the player B located at position 214 in the real world has a corresponding position 224 in the virtual world. As the players move about in a range of geographic coordinates in the real world, the players also move about in the range of coordinates defining the virtual space in the virtual world 210. In particular, a positioning system (e.g., a GPS system) associated with a mobile computing device carried by the player can be used to track a player's position as the player navigates the range of geographic coordinates in the real world. Data associated with the player's position in the real world 200 is used to update the player's position in the corresponding range of coordinates defining the virtual space in the virtual world 210. In this manner, players can navigate along a continuous track in the range of coordinates defining the virtual space in the virtual world 210 by simply traveling among the corresponding range of geographic coordinates in the real world 200 without having to check in or periodically update location information at specific discrete locations in the real world 200.

The location-based game can include a plurality of game objectives requiring players to travel to and/or interact with various virtual elements and/or virtual objects scattered at various virtual locations in the virtual world. A player can travel to these virtual locations by traveling to the corresponding location of the virtual elements or objects in the real world. For instance, a positioning system can continuously track the position of the player such that as the player continuously navigates the real world, the player also continuously navigates the parallel virtual world. The player can then interact with various virtual elements and/or objects at the specific location to achieve or perform one or more game objectives.

For example, a game objective has players interacting with virtual elements 230 located at various virtual locations in the virtual world 210. These virtual elements 230 can be linked to landmarks, geographic locations, or objects 240 in the real world 200. The real-world landmarks or objects 240 can be works of art, monuments, buildings, businesses, libraries, museums, or other suitable real-world landmarks or objects. Interactions include capturing, claiming ownership of, using some virtual item, spending some virtual currency, etc. To capture these virtual elements 230, a player must travel to the landmark or geographic location 240 linked to the virtual elements 230 in the real world and must perform any necessary interactions with the virtual elements 230 in the virtual world 210. For example, player A of FIG. 2 may have to travel to a landmark 240 in the real world 200 in order to interact with or capture a virtual element 230 linked with that particular landmark 240. The interaction with the virtual element 230 can require action in the real world, such as taking a photograph and/or verifying, obtaining, or capturing other information about the landmark or object 240 associated with the virtual element 230.

Game objectives may require that players use one or more virtual items that are collected by the players in the location-based game. For instance, the players may travel the virtual world 210 seeking virtual items (e.g. weapons, creatures, power ups, or other items) that can be useful for completing game objectives. These virtual items can be found or collected by traveling to different locations in the real world 200 or by completing various actions in either the virtual world 210 or the real world 200. In the example shown in FIG. 2, a player uses virtual items 232 to capture one or more virtual elements 230. In particular, a player can deploy virtual items 232 at locations in the virtual world 210 proximate or within the virtual elements 230. Deploying one or more virtual items 232 in this manner can result in the capture of the virtual element 230 for the particular player or for the team/faction of the particular player.

In one particular implementation, a player may have to gather virtual energy as part of the parallel reality game. As depicted in FIG. 2, virtual energy 250 can be scattered at different locations in the virtual world 210. A player can collect the virtual energy 250 by traveling to the corresponding location of the virtual energy 250 in the actual world 200. The virtual energy 250 can be used to power virtual items and/or to perform various game objectives in the game. A player that loses all virtual energy 250 can be disconnected from the game.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. In some embodiments, players can communicate with one another through one or more communication interfaces provided in the game. Players can also obtain enhanced “powers” or virtual items that can be used to complete game objectives within the game. Those of ordinary skill in the art, using the disclosures provided herein, should understand that various other game features can be included with the parallel reality game without deviating from the scope of the present disclosure.

Referring back FIG. 1, the networked computing environment 100 uses a client-server architecture, where a game server 120 communicates with a client device 110 over a network 105 to provide a parallel reality game to players at the client device 110. The networked computing environment 100 also may include other external systems such as sponsor/advertiser systems or business systems. Although only one client device 110 is illustrated in FIG. 1, any number of clients 110 or other external systems may be connected to the game server 120 over the network 105. Furthermore, the networked computing environment 100 may contain different or additional elements and functionality may be distributed between the client device 110 and the server 120 in a different manner than described below.

A client device 110 can be any portable computing device that can be used by a player to interface with the game server 120. For instance, a client device 110 can be a wireless device, a personal digital assistant (PDA), portable gaming device, cellular phone, smart phone, tablet, navigation system, handheld GPS system, wearable computing device, a display having one or more processors, or other such device. In another instance, the client device 110 includes a conventional computer system, such as a desktop or a laptop computer. Still yet, the client device 110 may be a vehicle with a computing device. In short, a client device 110 can be any computer device or system that can enable a player to interact with the game server 120. As a computing device, the client device 110 can include one or more processors and one or more computer-readable storage media. The computer-readable storage media can store instructions which cause the processor to perform operations. The client device 110 is preferably a portable computing device that can be easily carried or otherwise transported with a player, such as a smartphone or tablet.

The client device 110 communicates with the game server 120 providing the game server 120 with sensory data of a physical environment. The client device 110 includes a camera assembly 125 that captures image data in two dimensions of a scene in the physical environment where the client device 110 is. In the embodiment shown in FIG. 1, each client device 110 includes software components such as a gaming module 135 and a positioning module 140. The client device 110 also includes a panoptic segmentation module 142 for panoptic segmentation forecasting. The client device 110 may include various other input/output devices for receiving information from and/or providing information to a player. Example input/output devices include a display screen, a touch screen, a touch pad, data entry keys, speakers, and a microphone suitable for voice recognition. The client device 110 may also include other various sensors for recording data from the client device 110 including but not limited to movement sensors, accelerometers, gyroscopes, other inertial measurement units (IMUs), barometers, positioning systems, thermometers, light sensors, etc. The client device 110 can further include a network interface for providing communications over the network 105. A network interface can include any suitable components for interfacing with one more networks, including for example, transmitters, receivers, ports, controllers, antennas, or other suitable components.

The camera assembly 125 captures image data of a scene of the environment where the client device 110 is in. The camera assembly 125 may utilize a variety of varying photo sensors with varying color capture ranges at varying capture rates. The camera assembly 125 may contain a wide-angle lens or a telephoto lens. The camera assembly 125 may be configured to capture single images or video as the image data. Additionally, the orientation of the camera assembly 125 could be parallel to the ground with the camera assembly 125 aimed at the horizon. The camera assembly 125 captures image data and shares the image data with the computing device on the client device 110. The image data can be appended with metadata describing other details of the image data including sensory data (e.g. temperature, brightness of environment) or capture data (e.g. exposure, warmth, shutter speed, focal length, capture time, etc.). The camera assembly 125 can include one or more cameras which can capture image data. In one instance, the camera assembly 125 comprises one camera and is configured to capture monocular image data. In another instance, the camera assembly 125 comprises two cameras and is configured to capture stereoscopic image data. In various other implementations, the camera assembly 125 comprises a plurality of cameras each configured to capture image data.

The gaming module 135 provides a player with an interface to participate in the parallel reality game. The game server 120 transmits game data over the network 105 to the client device 110 for use by the gaming module 135 at the client device 110 to provide local versions of the game to players at locations remote from the game server 120. The game server 120 can include a network interface for providing communications over the network 105. A network interface can include any suitable components for interfacing with one more networks, including for example, transmitters, receivers, ports, controllers, antennas, or other suitable components.

The gaming module 135 executed by the client device 110 provides an interface between a player and the parallel reality game. The gaming module 135 can present a user interface on a display device associated with the client device 110 that displays a virtual world (e.g. renders imagery of the virtual world) associated with the game and allows a user to interact in the virtual world to perform various game objectives. In some other embodiments, the gaming module 135 presents image data from the real world (e.g., captured by the camera assembly 125) augmented with virtual elements from the parallel reality game. In these embodiments, the gaming module 135 may generate virtual content and/or adjust virtual content according to other information received from other components of the client device 110. For example, the gaming module 135 may adjust a virtual object to be displayed on the user interface according to a depth map of the scene captured in the image data.

The gaming module 135 can also control various other outputs to allow a player to interact with the game without requiring the player to view a display screen. For instance, the gaming module 135 can control various audio, vibratory, or other notifications that allow the player to play the game without looking at the display screen. The gaming module 135 can access game data received from the game server 120 to provide an accurate representation of the game to the user. The gaming module 135 can receive and process player input and provide updates to the game server 120 over the network 105. The gaming module 135 may also generate and/or adjust game content to be displayed by the client device 110. For example, the gaming module 135 may generate a virtual element, e.g., based on images captured by the camera assembly 125, or a future panoptic segmentation generated by the panoptic segmentation module 142.

The positioning module 140 can be any device or circuitry for monitoring the position of the client device 110. For example, the positioning module 140 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, and/or other suitable techniques for determining position. The positioning module 140 may further include various other sensors that may aid in accurately positioning the client device 110 location.

As the player moves around with the client device 110 in the real world, the positioning module 140 tracks the position of the player and provides the player position information to the gaming module 135. The gaming module 135 updates the player position in the virtual world associated with the game based on the actual position of the player in the real world. Thus, a player can interact with the virtual world simply by carrying or transporting the client device 110 in the real world. In particular, the location of the player in the virtual world can correspond to the location of the player in the real world. The gaming module 135 can provide player position information to the game server 120 over the network 105. In response, the game server 120 may enact various techniques to verify the client device 110 location to prevent cheaters from spoofing the client device 110 location. It should be understood that location information associated with a player is utilized only if permission is granted after the player has been notified that location information of the player is to be accessed and how the location information is to be utilized in the context of the game (e.g. to update player position in the virtual world). In addition, any location information associated with players will be stored and maintained in a manner to protect player privacy.

The panoptic segmentation module 142 predicts a future panoptic segmentation from input frames captured by the camera assembly 125. The panoptic segmentation module 142 classifies pixels in the input frames as either relating to foreground objects or background objects. From the foreground pixels, the panoptic segmentation module 142 identifies foreground objects and applies a foreground motion model to forecast future positions of the foreground objects. With the background pixels, the panoptic segmentation module 142 applies a background motion model to forecast future positions of the background pixels. One embodiment employs backprojection of background pixels into a 3D point cloud space and forecasting the 3D point clouds with the background motion model. The panoptic segmentation module 142 layers future positions of the foreground objects onto the future positions of the background objects to create a future panoptic segmentation. The panoptic segmentation module 142 may additionally use positioning information determined by the positioning module 140 in panoptic segmentation.

A future panoptic segmentation is used by other components of the client device 110. For example, the gaming module 135 may generate virtual objects for augmented reality based on the future panoptic segmentation. This would allow for the virtual object to interact with the environment with little to minimal lag, i.e., avoiding situations where a real object collides with the virtual object but the virtual object is unchanged. In embodiments with the client device 110 as a vehicle, other components may generate control signals for navigating the vehicle based on the future panoptic segmentation. The control signals may be proactive in avoiding collisions with objects in the environment.

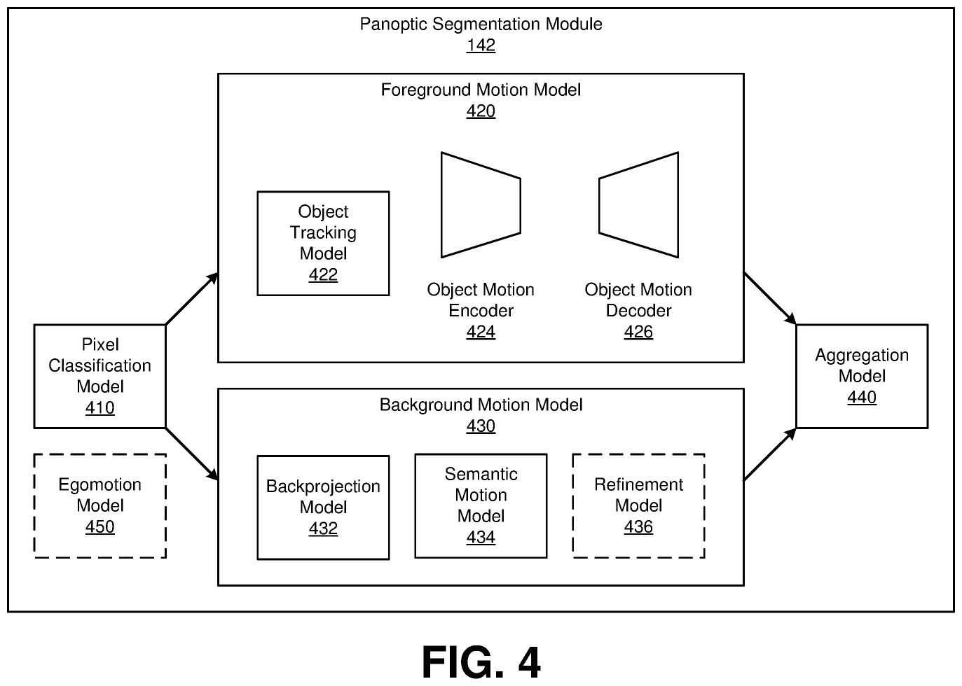

Referring now to FIG. 4, FIG. 4 is a block diagram illustrating the architecture of the panoptic segmentation module 142, in accordance with one or more embodiments. The panoptic segmentation module 142 includes a pixel classification model 410, a foreground motion model 420, a background motion model 430, and an aggregation model 440. The panoptic segmentation module 142 may also include an egomotion model 450 for modeling motion of the client device 110.

The pixel classification model 410 classifies pixels in input frames captured by the camera assembly 135 as either relating to the foreground or the background. The pixel classification model 410 may also group foreground pixels that relate to individual foreground objects. In one embodiment the pixel classification model 410 groups foregrounds pixels relating to individual foreground objects with the remaining pixels labeled as background. The pixel classification model 410 may additionally classify each identified foreground object into categories. For example, categories may include pedestrians, bikers, cars, pets, etc. The categories may be further subdivided into sub-categories, e.g., pedestrian split into walkers, runners, etc. In one implementation, the pixel classification model 410 implements a machine learning algorithm, e.g., MaskRCNN to group foreground pixels relating to individual foreground objects. In some embodiments, the pixel classification model 410 further categorizes background pixels into a plurality of labels, e.g., ground, sky, building, trees, etc. Foreground pixels and/or foreground objects are provided to the foreground motion model 420, and background pixels are provided to the background motion model 430. In one or more embodiments, the pixel classification model 410 may leverage egomotion as determined by the egomotion model 450 in the process of classifying pixels between foreground and background. For example, the egomotion model 450 determines egomotion of the camera capturing the frames, and the pixel classification model 410 may identify objects or pixels moving at a different rate than the egomotion as indicative of foreground objects.

The foreground motion model 420 forecasts motion of foreground pixels in the input frames. In accordance with one or more embodiments, the foreground motion model 420 includes an object tracking model 422, an object motion encoder 424, and an object motion decoder 426. The object tracking model 422 tracks a position of each foreground in each frame captured. The object motion encoder 424 inputs the captured frames and outputs abstract features relating to predicted motion of each foreground object. The object motion decoder 426 inputs the abstract features and outputs predicted a future position for each foreground object, e.g., at a subsequent time from the input frames.

The object tracking model 422 tracks movement of foreground objects over time. The object tracking model 422 may implement machine learning algorithms, e.g., DeepSort. As the foreground motion model 420 (and its various components) predict positions and/or motion of the foreground objects, the object tracking model 422 may track the foreground objects in different input frames. As additional image data is captured, the object tracking model 422 may further track the position of the foreground objects based on the additional image data. In some embodiments, the object tracking model 422 may score a predicted position of a foreground object predicted by the foreground motion model 420 against the actual position of the foreground object in subsequently captured image data. The score may be utilized by the foreground motion model 420 to further refined the foreground motion model 420.

The object motion encoder 424 inputs frames including a foreground object identified by the object tracking model 422 and outputs abstract features relating to predicted motion for that foreground object. The object motion encoder 424 may also input egomotion determined by the egomotion model 450. In one or more embodiments, the object motion encoder 424 comprises two sub-encoders. For a foreground object, the objection motion encoder 424 inputs bounding box features, mask features, and odometry as determined by the pixel classification model 410 from the input frames. A bounding box feature may be the smallest rectangle that fully encompasses a foreground object. A mask feature may be a bitmap retaining pixels of a foreground object while excluding other pixels. The odometry of a foreground object can be measured by tracking movement of the foreground over the input frames. A first sub-encoder determines a box state representation from the bounding box features, the odometry, and a transformation of mask features. A second sub-encoder determines a mask state representation from mask features and the box state representation.

The object motion decoder 426 inputs the abstract features and outputs a predicted future position of each foreground object. In some embodiments, the foreground motion model 420 inputs a single foreground object (e.g., at a time) to predict a future position of that foreground object. In one or more embodiments, the object motion decoder 426 comprises two sub-decoders. A first sub-decoder predicts future bounding boxes, and a second sub-decoder predicts future mask features. The sub-decoders can predict a future position of that foreground object for each of a plurality of future timestamps. For example, input frames for t₁, t₂, . . . t_{T} (where t_{T} is the most recent timestamp of the input frames, and preceding timestamps) and can output a future position for t_{T+1}, t_{T+2}, . . . t_{T+F} (wherein t_{T+F} is the furthest future timestamp). The predicted future position may also change perspective and/or scale of the foreground objects.

The foreground motion model 420 may further consider a category of each foreground object. For example, the foreground motion model 420 may comprise a plurality of sub-models, each sub-model trained for each category of foreground object. This allows for more precise modeling of the motion for different categories of foreground objects. For example, vehicles can move very fast compared to pedestrians.

The background motion model 430 forecasts motion of background pixels in the input frames, i.e., predicts a future position of the background pixels. In accordance with one or more embodiments, the background motion model 430 includes a backprojection model 432, a semantic motion model 434, and optionally a refinement model 436.

The backprojection model 432 backprojects the background pixels into a 3D point cloud space as 3D point clouds based on depth of the background pixels. Depth may be determined by a stereo depth estimation model and/or a monodepth estimation model, e.g., described in U.S. application Ser. No. 16/332,343 entitled “Predicting Depth From Image Data Using a Statistical Model,” filed on Sep. 12, 2017; U.S. application Ser. No. 16/413,907 entitled “Self-Supervised Training of a Depth Estimation System,” filed on May 16, 2019; and U.S. application Ser. No. 16/864,743 entitled “Self-Supervised Training of a Depth Estimation Model Using Depth Hints,” filed on May 1, 2020. The backprojection model 432 generates a 3D point cloud space from the perspective of the input frames. The backprojection model 432 may further consider camera intrinsic parameters in the backprojection. For example, the backprojection model 432 utilizes a camera focal length and sensor size to establish a viewing frustum from the perspective of the camera. The backprojection model 432 may also utilize the camera focal length to estimate depth of the pixels. With the estimated depth for each pixel, the backprojection model 432 projects the pixel into a 3D point cloud based on the estimated depth.

The semantic motion model 434 forecasts the 3D point clouds based on egomotion determined by the egomotion model 450. The egomotion of the camera may include position, orientation, translational movement, rotational movement, etc. The egomotion may further include future egomotion, e.g., future position, future orientation, future translational movement, future rotational movement, etc. Based on the future egomotion, the semantic motion model 434 may translate the 3D point clouds to account for a future position of the camera.

The refinement model 436 fills in such gaps using the forecasted 3D point clouds. There may be sparsity of point clouds and lack of information in regions of previously occluded pixels. To train the background refinement model, a cross-entropy loss is applied at pixels which do not correspond to foreground objects in the target frame. This encourages the output of the refinement model 436 to match the ground truth semantic segmentation at each pixel. To fill the gaps, the refinement model 436 may generate novel point clouds interpolating from the existing point clouds.

The aggregation model 440 layers the future positions of the foreground pixels onto the future positions of the background pixels. The layering is ordered such that objects at closer depths are layered atop objects at farther depths. The result is a future panoptic segmentation that includes future positions of foreground objects and future positions of background objects.

In embodiments with the egomotion model 450, the egomotion model 450 estimates egomotion of the camera assembly 135. The egomotion model 450 may predict egomotion based on past motion of the camera assembly 135, e.g., implementing one or more machine learning algorithms. For example, the egomotion model 450 may utilize visual odometry in predicting past camera movement in the frames captured by the camera assembly 135. In some embodiments, the egomotion model 450 incorporates position data captured by the positioning module 140.

In one embodiment of the panoptic segmentation module 142 (not shown in FIG. 4), the foreground motion model 420 and the background motion model 430 output abstract features relating to motion of the foreground pixels and the background pixels. The aggregation model 440 may be a neural network trained to input the abstract features and output a future panoptic segmentation.

Referring back to FIG. 1, the game server 120 can be any computing device and can include one or more processors and one or more computer-readable storage media. The computer-readable storage media can store instructions which cause the processor to perform operations. The game server 120 can include or can be in communication with a game database 115. The game database 115 stores game data used in the parallel reality game to be served or provided to the client(s) 110 over the network 105.

The game data stored in the game database 115 can include: (1) data associated with the virtual world in the parallel reality game (e.g. imagery data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated with virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) Game status (e.g. current number of players, current status of game objectives, player leaderboard, etc.); (7) data associated with player actions/input (e.g. current player positions, past player positions, player moves, player input, player queries, player communications, etc.); and (8) any other data used, related to, or obtained during implementation of the parallel reality game. The game data stored in the game database 115 can be populated either offline or in real time by system administrators and/or by data received from users/players of the system 100, such as from a client device 110 over the network 105.

The game server 120 can be configured to receive requests for game data from a client device 110 (for instance via remote procedure calls (RPCs)) and to respond to those requests via the network 105. For instance, the game server 120 can encode game data in one or more data files and provide the data files to the client device 110. In addition, the game server 120 can be configured to receive game data (e.g. player positions, player actions, player input, etc.) from a client device 110 via the network 105. For instance, the client device 110 can be configured to periodically send player input and other updates to the game server 120, which the game server 120 uses to update game data in the game database 115 to reflect any and all changed conditions for the game.

In the embodiment shown, the server 120 includes a universal gaming module 145, a commercial game module 150, a data collection module 155, an event module 160, and a panoptic segmentation training system 170. As mentioned above, the game server 120 interacts with a game database 115 that may be part of the game server 120 or accessed remotely (e.g., the game database 115 may be a distributed database accessed via the network 105). In other embodiments, the game server 120 contains different and/or additional elements. In addition, the functions may be distributed among the elements in a different manner than described. For instance, the game database 115 can be integrated into the game server 120.

The universal game module 145 hosts the parallel reality game for all players and acts as the authoritative source for the current status of the parallel reality game for all players. As the host, the universal game module 145 generates game content for presentation to players, e.g., via their respective client devices 110. The universal game module 145 may access the game database 115 to retrieve and/or store game data when hosting the parallel reality game. The universal game module 145 also receives game data from client device 110 (e.g. depth information, player input, player position, player actions, landmark information, etc.) and incorporates the game data received into the overall parallel reality game for all players of the parallel reality game. The universal game module 145 can also manage the delivery of game data to the client device 110 over the network 105. The universal game module 145 may also govern security aspects of client device 110 including but not limited to securing connections between the client device 110 and the game server 120, establishing connections between various client device 110, and verifying the location of the various client device 110.

The commercial game module 150, in embodiments where one is included, can be separate from or a part of the universal game module 145. The commercial game module 150 can manage the inclusion of various game features within the parallel reality game that are linked with a commercial activity in the real world. For instance, the commercial game module 150 can receive requests from external systems such as sponsors/advertisers, businesses, or other entities over the network 105 (via a network interface) to include game features linked with commercial activity in the parallel reality game. The commercial game module 150 can then arrange for the inclusion of these game features in the parallel reality game.

The game server 120 can further include a data collection module 155. The data collection module 155, in embodiments where one is included, can be separate from or a part of the universal game module 145. The data collection module 155 can manage the inclusion of various game features within the parallel reality game that are linked with a data collection activity in the real world. For instance, the data collection module 155 can modify game data stored in the game database 115 to include game features linked with data collection activity in the parallel reality game. The data collection module 155 can also analyze and data collected by players pursuant to the data collection activity and provide the data for access by various platforms.

The event module 160 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The panoptic segmentation training system 170 trains the models used by the panoptic segmentation module 142. The panoptic segmentation training system 170 receives image data for use in training the models of the panoptic segmentation module 142. Generally, the panoptic segmentation training system 170 may perform supervised training of the models of the panoptic segmentation module 142. The training of the models may be simultaneous or separate. With supervised training, a data set used to train a particular model or models has a ground truth that a prediction is evaluated against to calculate a loss. The training system 170 iteratively adjusts weights of the models to optimize the loss. As a future panoptic segmentation predicts future positions of foreground objects and future positions of background objects in a scene, a video captured by a camera on a moving agent can be used for supervised training. The training system 170 inputs a subset of frames and attempts to generate a future panoptic segmentation at a subsequent timestamp in the video. The training system 170 may compare the future panoptic segmentation to the frame at that subsequent timestamp.

This principle applies to each of the components of the panoptic segmentation module 142. For example, taking the foreground motion model 420, the training system 170 subdivides the video into input frames and ground truth future positions. For example, the training system 170 uses a sliding window to capture subsets of some number of adjacent timestamped frames (e.g., grouping into six frames). A supposed current timestamp is used to split each subset of adjacent timestamped frames into training input frames and training ground truth frames (e.g., three out of six frames are training input frames and three out of six frames are training ground truth frames). The training system 170 inputs the training input frames into the foreground motion model 420 to predict future positions of the foreground objects which is compared against the training ground truth frames to calculate a loss for the foreground motion model 420. And with the background motion model 430, the training system 170 may use a similar subdivision of video data. The training system 170 inputs the training input frames into the background motion model 430 to determine future position of the background pixels which is compared against the training ground truth frames to calculate a loss for the background motion model 430.

Once the panoptic segmentation module 142 is trained, the panoptic segmentation module 142 receives image data and outputs a panoptic segmentation predicting future positions of pixels in the input image data. The panoptic segmentation training system 170 provides the trained panoptic segmentation module 142 to the client device 110. The client device 110 uses the trained panoptic segmentation module 142 to predict a future panoptic segmentation based on input images (e.g., captured by a camera on the device).

Various embodiments of panoptic segmentation forecasting and approaches to training the various models of the panoptic segmentation module 142 are described in greater detail in Appendix A, which is a part of this disclosure and specification. Note that Appendix A describes exemplary embodiments, and any features that may be described as or implied to be important, critical, essential, or otherwise required in Appendix A should be understood to only be required in the specific embodiment described and not required in all embodiments.

The network 105 can be any type of communications network, such as a local area network (e.g. intranet), wide area network (e.g. Internet), or some combination thereof. The network 105 can also include a direct connection between a client device 110 and the game server 120. In general, communication between the game server 120 and a client device 110 can be carried via a network interface using any type of wired and/or wireless connection, using a variety of communication protocols (e.g. TCP/IP, HTTP, SMTP, FTP), encodings or formats (e.g. HTML, XML, JSON), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

In addition, in situations in which the systems and methods discussed herein access and analyze personal information about users, or make use of personal information, such as location information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Exemplary Game Interface

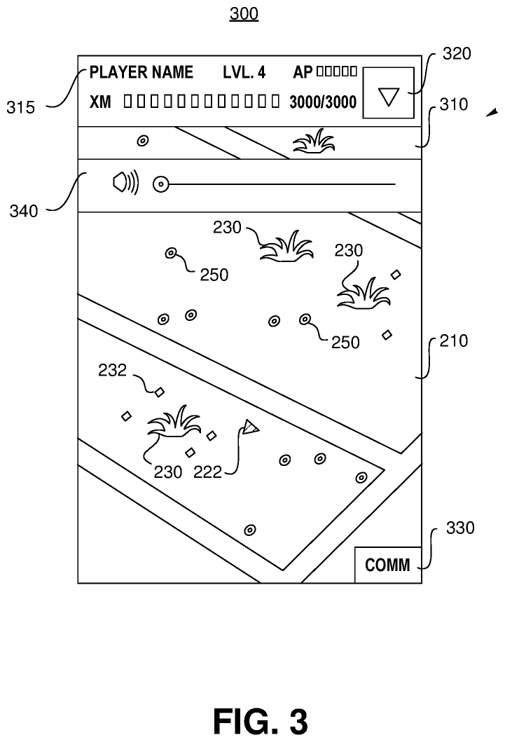

FIG. 3 depicts one embodiment of a game interface 300 that can be presented on a display of a client 110 as part of the interface between a player and the virtual world 210. The game interface 300 includes a display window 310 that can be used to display the virtual world 210 and various other aspects of the game, such as player position 222 and the locations of virtual elements 230, virtual items 232, and virtual energy 250 in the virtual world 210. The user interface 300 can also display other information, such as game data information, game communications, player information, client location verification instructions and other information associated with the game. For example, the user interface can display player information 315, such as player name, experience level and other information. The user interface 300 can include a menu 320 for accessing various game settings and other information associated with the game. The user interface 300 can also include a communications interface 330 that enables communications between the game system and the player and between one or more players of the parallel reality game.

According to aspects of the present disclosure, a player can interact with the parallel reality game by simply carrying a client device 110 around in the real world. For instance, a player can play the game by simply accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 300 can include a plurality of non-visual elements that allow a user to interact with the game. For instance, the game interface can provide audible notifications to the player when the player is approaching a virtual element or object in the game or when an important event happens in the parallel reality game. A player can control these audible notifications with audio control 340. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

Those of ordinary skill in the art, using the disclosures provided herein, will appreciate that numerous game interface configurations and underlying functionalities will be apparent in light of this disclosure. The present disclosure is not intended to be limited to any one particular configuration.

### Example Methods

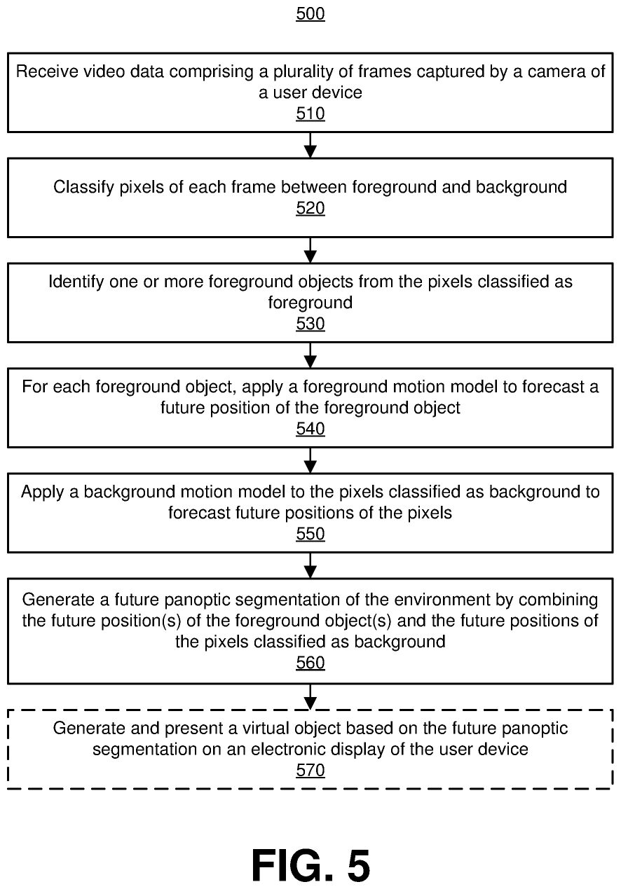

FIG. 5 is a flowchart describing a general process 500 of panoptic segmentation forecasting, in accordance with one or more embodiments. The process 500 yields a future panoptic segmentation describing future position(s) of one or more foreground objects layered onto future position(s) of one or more background objects. Some of the steps of FIG. 5 are illustrated from the perspective of the panoptic segmentation module 142. However, some or all of the steps may be performed by other entities and/or components. In addition, some embodiments may perform the steps in parallel, perform the steps in different orders, or perform different steps.

The panoptic segmentation module 142 receives 510 video data comprising a plurality of frames captured by a camera of a user device, e.g., the camera assembly 135.

The panoptic segmentation module 142 classifies 520 pixels of each frame between foreground and background. The panoptic segmentation module 142 may implement a pixel classification model, e.g., the pixel classification model 410 of FIG. 4, to classify pixels as foreground or background. In one or more embodiments, the panoptic segmentation module 142 affirmatively identifies foreground pixels, whereas remaining pixels not identified as foreground pixels are classified as background pixels.

The panoptic segmentation module 142 identifies 530 one or more foreground objects from the pixels classified as foreground. The panoptic segmentation module 142 may group foreground pixels into individual foreground objects. The panoptic segmentation module 142 may further categorize foreground objects into one of a plurality of categories, e.g., vehicle, pedestrian, biker, pet, etc. Foreground pixels and/or foreground objects may move while the user device is also moving. Background pixels generally are stationary, such that their positions change due to user device motion. The panoptic segmentation module 142 may further categorize the background pixels as belonging to one of a second plurality of categories, e.g., ground, sky, foliage, etc.

The panoptic segmentation module 142, for each foreground object, applies 540 a foreground motion model to forecast a future position of the foreground object at a future timestamp. The foreground motion model may include an object motion encoder and an object motion decoder (e.g., the object motion encoder 424 and the object motion decoder 426). The object motion encoder determines abstract features relating to motion of the foreground object(s) while the object motion decoder determines the future position(s) of the foreground object(s) at the future timestamp.

The panoptic segmentation module 142 applies 550 a background motion model to the background pixels to forecast future positions of the background pixels. The panoptic segmentation module 142 may backproject (e.g., via the backprojection model 432) background pixels into 3D point cloud space based on depth information of the background pixels. The panoptic segmentation module 142 may predict future positions of the background pixels at the future timestamp based on egomotion of the user device (e.g., as determined by the egomotion model 450). In some embodiments, background objects are identified and backprojection of the background objects into 3D point cloud space may take into account background object geometry. In some embodiments, the panoptic segmentation module 142 applies a refinement model (e.g., the refinement model 436) to fill in gaps of the background due to occlusion by the foreground object(s).

The panoptic segmentation module 142 generates 560 a future panoptic segmentation of the environment by layering future position(s) of the foreground object(s) onto the future position(s) of the background object(s). The panoptic segmentation module 142 may layer the objects based on nearest depth, i.e., objects that are closer are placed in front of objects that are farther. The resulting future panoptic segmentation is at the future timestamp. The future panoptic segmentation distinguishes from the foreground object(s) from the background pixels.

With the future panoptic segmentation, the gaming module 135 may generate and present a virtual object based on the future panoptic segmentation on an electronic display of the user device. The virtual object may be generated to interact seamlessly with the objects in the scene captured by the camera of the user device. For example, the virtual object will be displayed to avoid collision with a foreground object based on the future position of that foreground object as determined in the future panoptic segmentation.

Alternative applications of panoptic segmentation forecasting include autonomous navigation of an agent within an environment. For example, the camera may be positioned on the agent. A navigational control system may determine a navigational route based on the future panoptic segmentation. For example, the navigational control system predicts that a pedestrian will be positioned directly in front of the agent 1 second from the most recent video captured. The navigational control system may determine evasive maneuvers to avoid collision with the pedestrian.

### Example Computing System

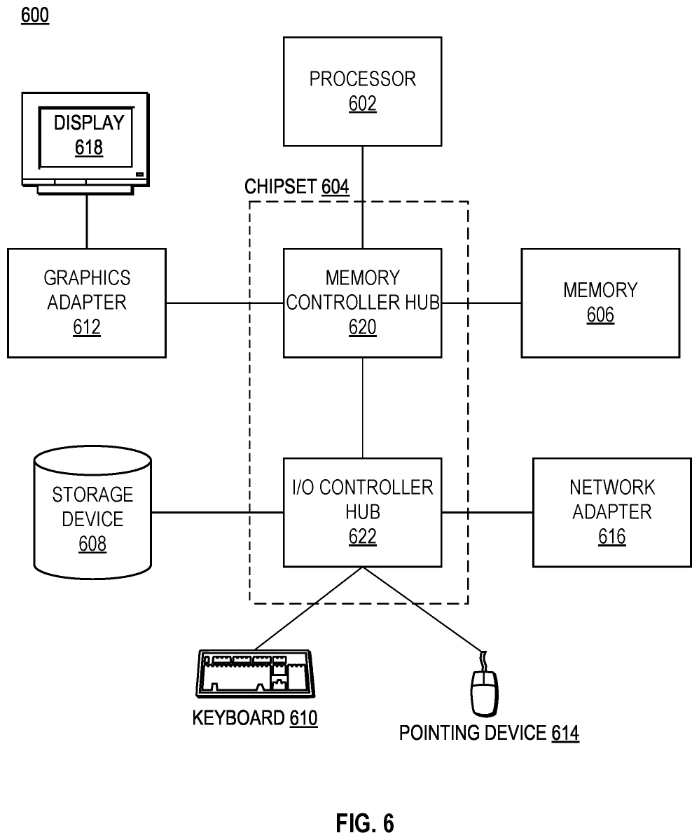

FIG. 6 is an example architecture of a computing device, according to an embodiment. Although FIG. 6 depicts a high-level block diagram illustrating physical components of a computer used as part or all of one or more entities described herein, in accordance with an embodiment, a computer may have additional, less, or variations of the components provided in FIG. 6. Although FIG. 6 depicts a computer 600, the figure is intended as functional description of the various features which may be present in computer systems than as a structural schematic of the implementations described herein. In practice, and as recognized by those of ordinary skill in the art, items shown separately could be combined and some items could be separated.

Illustrated in FIG. 6 are at least one processor 602 coupled to a chipset 604. Also coupled to the chipset 604 are a memory 606, a storage device 608, a keyboard 610, a graphics adapter 612, a pointing device 614, and a network adapter 616. A display 618 is coupled to the graphics adapter 612. In one embodiment, the functionality of the chipset 604 is provided by a memory controller hub 620 and an I/O hub 622. In another embodiment, the memory 606 is coupled directly to the processor 602 instead of the chipset 604. In some embodiments, the computer 600 includes one or more communication buses for interconnecting these components. The one or more communication buses optionally include circuitry (sometimes called a chipset) that interconnects and controls communications between system components.

The storage device 608 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 608 can also be referred to as persistent memory. The pointing device 614 may be a mouse, track ball, or other type of pointing device, and is used in combination with the keyboard 610 to input data into the computer 600. The graphics adapter 612 displays images and other information on the display 618. The network adapter 616 couples the computer 600 to a local or wide area network.

The memory 606 holds instructions and data used by the processor 602. The memory 606 can be non-persistent memory, examples of which include high-speed random-access memory, such as DRAM, SRAM, DDR RAM, ROM, EEPROM, flash memory.

As is known in the art, a computer 600 can have different and/or other components than those shown in FIG. 13. In addition, the computer 600 can lack certain illustrated components. In one embodiment, a computer 600 acting as a server may lack a keyboard 610, pointing device 614, graphics adapter 612, and/or display 618. Moreover, the storage device 608 can be local and/or remote from the computer 600 (such as embodied within a storage area network (SAN)).

As is known in the art, the computer 600 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 608, loaded into the memory 606, and executed by the processor 602.

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for verifying an account with an on-line service provider corresponds to a genuine business. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

What is claimed is:

1. A method comprising:
receiving video data of an environment, the video data comprising frames captured by a camera of a user device;
classifying pixels of the frames between foreground and background;
identifying a foreground object from the pixels classified as foreground;
applying a foreground motion model to forecast a future position of the foreground object at a future timestamp based on positions of the foreground object in the frames;
applying a background motion model to the pixels classified as background to forecast, based on estimated depths in the frames, future positions at the future timestamp of the pixels classified as background;
generating a future panoptic segmentation of the environment by combining the future position of the foreground object at the future timestamp and the future positions of the pixels classified as background at the future timestamp;
generating a virtual object based on the future panoptic segmentation; and
presenting the virtual object layered onto video data on an electronic display of the user device.

2. The method of claim 1, wherein classifying pixels of each frame between foreground and background comprises applying a pixel classification model which is a machine-learned model.

3. The method of claim 1, wherein identifying one or more foreground objects from the pixels classified as foreground comprises determining, for the identified foreground object, (1) a group of pixels classified as foreground as part of the foreground object, and (2) a bounding box around the foreground object.

4. The method of claim 1, further comprising:
classifying the foreground object as one of a plurality of categories of foreground objects,
wherein the foreground motion model forecasts a future position of the foreground object based in part on the category classified for the foreground object.

5. The method of claim 1, wherein the foreground motion model is a machine-learned model comprising:
an encoder configured to input the foreground object and to output abstract motion features; and
a decoder configured to input the abstract motion features and to predict a future position of the foreground object.

6. The method of claim 1, further comprising:
applying a depth estimation model to estimate depths of the pixels in the frames.

7. The method of claim 6, wherein the depth estimation model is a machine-learned model trained using training images with ground truth depth, wherein the depth estimation model is configured to input a frame and to output depths for pixels of the frame.

8. The method of claim 1, wherein applying the background motion model to the pixels classified as background comprises:
backprojecting the pixels classified as background into point clouds in a three-dimensional (3D) space based on the estimated depths;
forecasting motion of the point clouds based on motion in the frames; and
generating one or more novel point clouds by interpolating the 3D point clouds.

9. The method of claim 1, wherein combining the future position of the foreground object at the future timestamp and the future positions of the pixels classified as background at the future timestamp comprises layering the foreground object and the pixels classified as background based on depth.

10. The method of claim 1, wherein combining the future position of the foreground object at the future timestamp and the future positions of the pixels classified as background at the future timestamp comprises applying a machine-learned model to the generate the future panoptic segmentation of the environment.

11. A non-transitory computer-readable storage medium storing instructions that, when executed by a processor, cause the processor to perform operations comprising:
receiving video data of an environment, the video data comprising frames captured by a camera of a user device;
classifying pixels of the frames between foreground and background;
identifying a foreground object from the pixels classified as foreground;
applying a foreground motion model to forecast a future position of the foreground object at a future timestamp based on positions of the foreground object in the frames;
applying a background motion model to the pixels classified as background to forecast, based on estimated depths in the frames, future positions at the future timestamp of the pixels classified as background;
generating a future panoptic segmentation of the environment by combining the future position of the foreground object at the future timestamp and the future positions of the pixels classified as background at the future timestamp;
generating a virtual object based on the future panoptic segmentation; and
presenting the virtual object layered onto video data on an electronic display of the user device.

12. The non-transitory computer-readable storage medium of claim 11, wherein classifying pixels of each frame between foreground and background comprises applying a pixel classification model which is a machine-learned model.

13. The non-transitory computer-readable storage medium of claim 11, wherein identifying one or more foreground objects from the pixels classified as foreground comprises determining, for the identified foreground object, (1) a group of pixels classified as foreground as part of the foreground object, and (2) a bounding box around the foreground object.

14. The non-transitory computer-readable storage medium of claim 11, the operations further comprising:
classifying the foreground object as one of a plurality of categories of foreground objects,
wherein the foreground motion model forecasts a future position of the foreground object based in part on the category classified for the foreground object.

15. The non-transitory computer-readable storage medium of claim 11, wherein the foreground motion model is a machine-learned model comprising:
an encoder configured to input the foreground object and to output abstract motion features; and
a decoder configured to input the abstract motion features and to predict a future position of the foreground object.

16. The non-transitory computer-readable storage medium of claim 11, further comprising:
applying a depth estimation model to estimate depths of the pixels in the frames.

17. The non-transitory computer-readable storage medium of claim 16, wherein the depth estimation model is a machine-learned model trained using training images with ground truth depth, wherein the depth estimation model is configured to input a frame and to output depths for pixels of the frame.

18. The non-transitory computer-readable storage medium of claim 11, wherein applying the background motion model to the pixels classified as background comprises:
backprojecting the pixels classified as background into point clouds in a three-dimensional (3D) space based on the estimated depths;
forecasting motion of the point clouds based on motion in the frames; and
generating one or more novel point clouds by interpolating the 3D point clouds.

19. The non-transitory computer-readable storage medium of claim 11, wherein combining the future position of the foreground object at the future timestamp and the future positions of the pixels classified as background at the future timestamp comprises layering the foreground object and the pixels classified as background based on depth.

20. The non-transitory computer-readable storage medium of claim 11, wherein combining the future position of the foreground object at the future timestamp and the future positions of the pixels classified as background at the future timestamp comprises applying a machine-learned model to the generate the future panoptic segmentation of the environment.

21. A method comprising:
receiving video data of an environment surrounding a vehicle, the video data comprising frames captured by a camera mounted on the vehicle;
classifying pixels of the frames between foreground and background;
identifying a foreground object from the pixels classified as foreground;
applying a foreground motion model to forecast a future position of the foreground object at a future timestamp based on positions of the foreground object in the frames;
applying a background motion model to the pixels classified as background to forecast, based on estimated depths in the frames, future positions at the future timestamp of the pixels classified as background;
generating a future panoptic segmentation of the environment by combining the future position of the foreground object at the future timestamp and the future positions of the pixels classified as background at the future timestamp;
generating control signals for navigating the vehicle in the environment based on the future panoptic segmentation.
